(19) United States
(12) Patent Application Publication
(10) Pub. No.: US 2015/0169566 A1
(43) Pub. Date: Jun. 18, 2015

(54) MEDIA FILE DISPLAYING METHOD AND AREA NETWORK SYSTEM

(71) Applicant: PRIMAX ELECTRONICS LTD., TAIPEI (TW)

(72) Inventor: JUNG-CHANG YANG, TAIPEI (TW)

(73) Assignee: PRIMAX ELECTRONICS LTD., TAIPEI (TW)

(21) Appl. No.: 14/251,979

(22) Filed: Apr. 14, 2014

(30) Foreign Application Priority Data
Dec. 17, 2013 (TW) 102146619

(51) Int. Cl. G06F 17/30; H04L 29/08

(52) U.S. Cl. CPC G06F 17/30023; H04L 67/1097; G06F 17/30194

(57) ABSTRACT

A media file displaying method is provided. Firstly, a network communication of an area network system is established. Then, a shared folder in the area network system is searched. Consequently, a folder property information corresponding to the shared folder is acquired by the area network system. The first electronic device of the area network system writes the folder property information into a folder metadata of the shared folder. Consequently, the shared folder is correlated with a virtual folder of the first electronic device. Afterwards, the shared folder and the media file in the shared folder are displayed on a second electronic device, which is connected with the first electronic device.

### FIELD OF THE INVENTION

The present invention relates to a media file displaying method, and more particularly to a media file displaying method for an area network system.

### BACKGROUND OF THE INVENTION

Generally, an area network system comprises a local area network (LAN) system, a metropolitan area network (MAN) system and a wide area network (WAN) system. With increasing development of science and technology, the area network system further comprises a universal plug and play (UPnP) system and a Digital Living Network Alliance (DLNA) system. For example, the DLNA system is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some architectures of the DLNA system will be illustrated as follows. FIG. 1 schematically illustrates the architecture of a first conventional DLNA system. As shown in FIG. 1, the first conventional DLNA system 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. The digital media server 11 comprises a first storage element 111 for storing a media file 15. The media file 15 is for example an audio file, a photo file or a video file. After the digital media player 12 is in communication with the digital media server 11, the digital media player 12 may search the media file 15 from the digital media server 11. After the media file 15 is selected by the user through the digital media player 12, the media file 15 is transmitted from the digital media server 11 to a second storage element 121 of the digital media player 12. After the media file 15 is received by the digital media player 12, the media file 15 that is temporarily stored in the second storage element 121 can be played by the digital media player 12.

FIG. 2 schematically illustrates the architecture of a second conventional DLNA system. As shown in FIG. 2, the second conventional DLNA system 2 comprises a network router 20, a digital media server (DMS) 21, and a digital media renderer (DMR) 23. The communication between the digital media server 21 and the digital media renderer 23 is established through the network router 20. Similarly, the digital media server 21 comprises a first storage element 211 for storing a media file 25. In addition, the digital media server 21 further provides a control function of controlling operations of the digital media renderer 23. The digital media renderer 23 is used for receiving and playing the media file 25 that is transmitted from the digital media server 21. After the control function of the digital media server 21 is utilized to select the stored media file 25 from the digital media server 21, the media file 25 is transmitted from the digital media server 21 to the digital media renderer 23. Consequently, the media file 25 can be played by the digital media renderer 23.

FIG. 3 schematically illustrates the architecture of a third conventional DLNA system. As shown in FIG. 3, the third conventional DLNA system 3 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 comprises a first storage element for storing a media file 35. The digital media renderer 33 is used for receiving and playing the media file 35 that is transmitted from the digital media server 31. The digital media controller 34 provides a control function. After the control function of the digital media controller 34 is utilized to select the stored media file 35 from the digital media server 31, the media file 35 is transmitted from the digital media server 31 to the digital media renderer 33. Consequently, the media file 35 can be played by the digital media renderer 33.

As mentioned above, the digital media server, the digital media controller, the digital media renderer and the digital media player included in the same DLNA system may transfer or play media files through the network router. The digital media server and the digital media renderer may be referred as passive control devices that can be controlled. Moreover, the digital media controller and the digital media player may be referred as active control devices that can control the passive control devices. For example, a user in a living room may allow a mobile phone to be connected to a computer host in a study room. Moreover, through the mobile phone, the user may browse the audio files in the computer host and select a desired audio file from the computer host. Then, the selected audio file is transmitted from the mobile phone to a stereo device in the living room. After the audio file is received by the stereo set, the audio file is played by the stereo device. Consequently, the purposes of conveniently and quickly sharing media contents can be achieved by the DLNA system.

In other words, it is an important issue to develop the DLNA system or any other area network system so as enhance the operating convenience of the area network system. Therefore, there is a need of providing a media file displaying method for facilitating the user to view media files and an area network system for displaying the media files.

### SUMMARY OF THE INVENTION

An object of the present invention provides a media file displaying method for facilitating the user to view media files.

Another object of the present invention provides an area network system for displaying the photo files.

In accordance with an aspect of the present invention, there is provided a media file displaying method. The media file displaying method includes the following steps. Firstly, a first electronic device searches a second electronic device in an area network system. Then, a shared folder list corresponding to the second electronic device is issued from the second electronic device to the first electronic device. The shared folder list contains a folder property information of a shared folder of the second electronic device. The first electronic device comprises a default folder. Then, the folder property information is written into a folder metadata of the shared folder according to the shared folder list. Then, the shared folder is correlated with a virtual folder of the first electronic device according to the folder metadata of the shared folder. Then, a third electronic device in the area network system communicates with the first electronic device through network connection, so that the default folder and the virtual folder corresponding to the shared folder are displayed on the third electronic device. Then, the default folder or the virtual folder is selected. If the default folder is selected, a first media file contained in the default folder is displayed on the third electronic device. Whereas, if the virtual folder is selected, a second media file corresponding to the virtual folder is displayed on the third electronic device.

In accordance with another aspect of the present invention, there is provided an area network system. The area network system includes a network router, an electronic device, a digital media server, and an active control device. The network router provides a network connection function. The electronic device is connected to the network router through network connection. The electronic device includes a second media file. The second media file is contained in a shared folder. A shared folder list corresponding to the shared folder is outputted from the electronic device. The digital media server is connected to the network router through network connection and connected to the electronic device via the network router through network connection. The digital media server stores a first media file and receives the shared folder list. The digital media server includes a storage element and a controlling unit. The storage element is disposed within the digital media server. The first media file is stored in the storage element. The first media file is contained in a default folder. The controlling unit is connected with the storage element. The controlling unit writes a folder property information of the shared folder into a folder metadata of the shared folder according to the shared folder list, so that the shared folder is correlated with a virtual folder of the digital media server. The active control device is connected to the network router through network connection and connected to the digital media server via the network router through network connection. The default folder and the virtual folder are displayed on the active control device. If the default folder is selected, the first media file contained in the default folder is displayed on the active control device. Whereas, if the virtual folder is selected, the second media file corresponding to the virtual folder is displayed on the active control device.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a first conventional DLNA system;

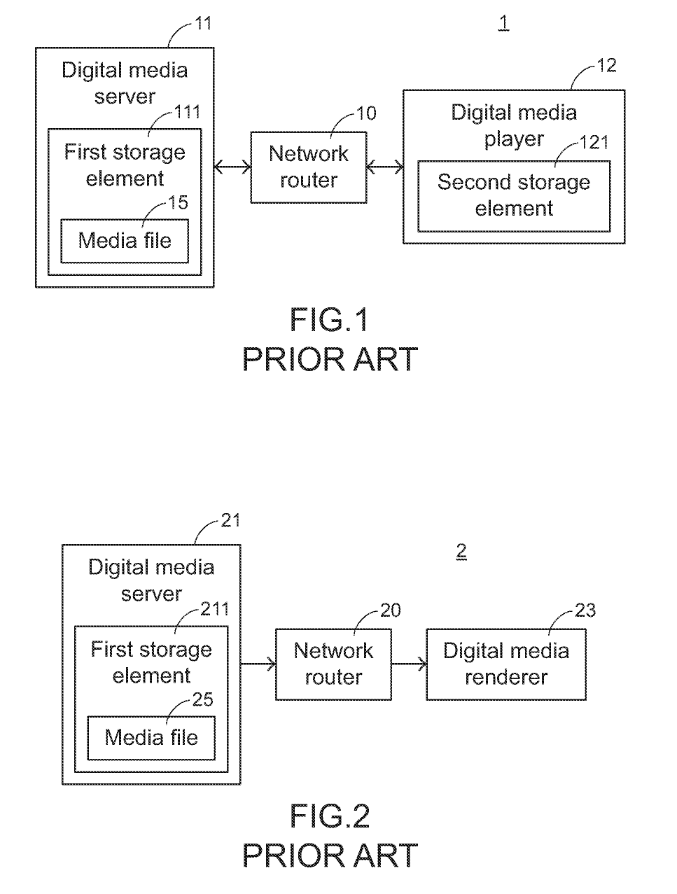

FIG. 2 schematically illustrates the architecture of a second conventional DLNA system;

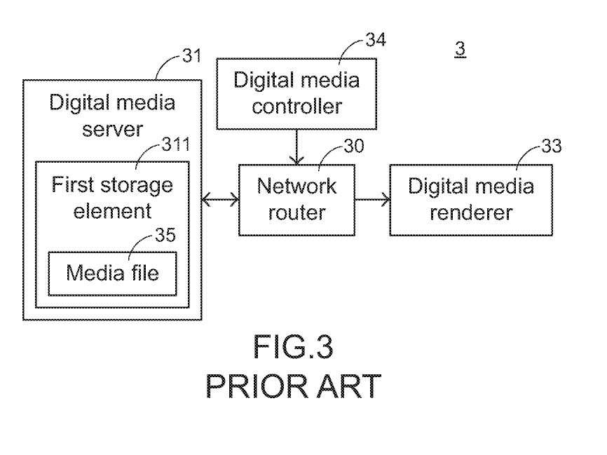

FIG. 3 schematically illustrates the architecture of a third conventional DLNA system;

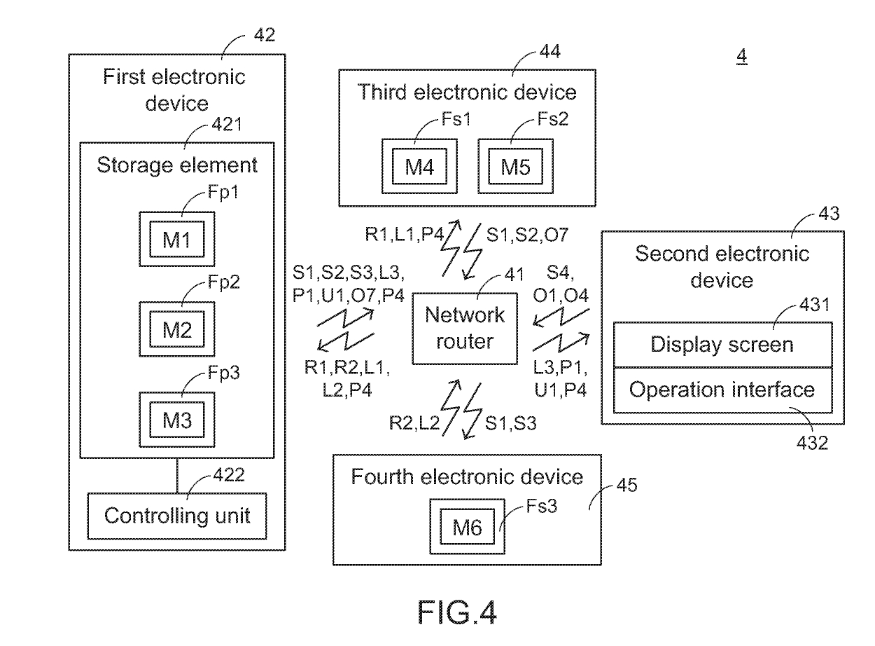

FIG. 4 is a schematic functional block diagram illustrating an area network system according to an embodiment of the present invention

FIGS. 5A and FIGS. 5B are flowcharts illustrating a media file displaying method according to an embodiment of the present invention;

FIG. 6 is a flowchart illustrating the step A of the media file displaying method according to the embodiment of the present invention;

FIGS. 7A and FIGS. 7B are flowcharts illustrating the step B of the media file displaying method according to the embodiment of the present invention;

FIG. 8 is a flowchart illustrating the step C of the media file displaying method according to the embodiment of the present invention;

FIG. 9 schematically illustrates a mount operation interface of the area network system according to the embodiment of the present invention;

FIG. 10 is a table indicating the folder metadata and the file metadata of the area network system according to the embodiment of the present invention; and

FIG. 11 schematically illustrates the folder architecture of the first electronic device of the area network system according to the embodiment of the present invention.

### DETAILED DESCRIPTION OF THE PREFERRED EMBODIMENT

For obviating the drawbacks of the prior art technologies, the present invention provides a media file displaying method and an area network system using the media file displaying method.

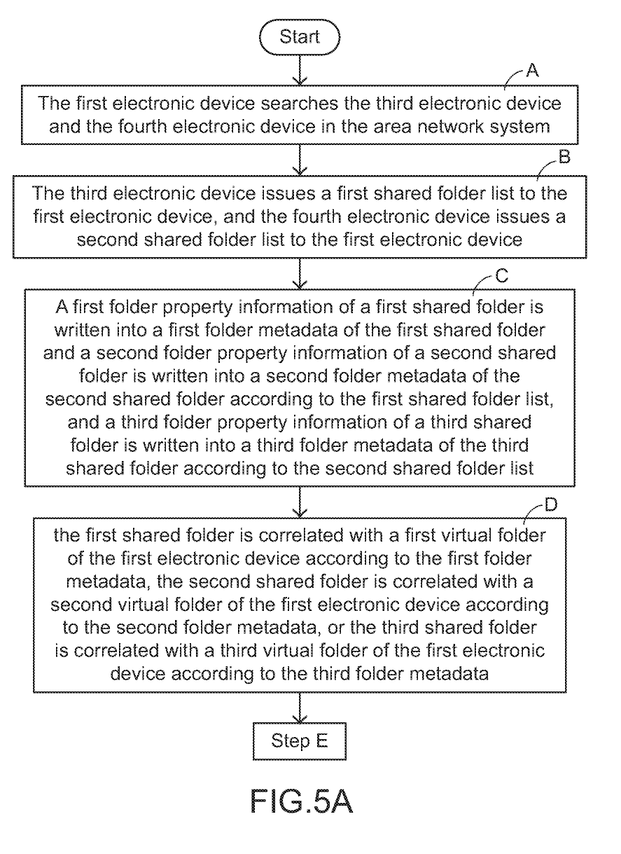

Hereinafter, an area network system of the present invention will be illustrated. FIG. 4 is a schematic functional block diagram illustrating an area network system according to an embodiment of the present invention. As shown in FIG. 4, the area network system 4 comprises a network router 41, a first electronic device 42, a second electronic device 43, a third electronic device 44, and a fourth electronic device 45. The network router 41 is used to provide a network connection function. The first electronic device 42, the second electronic device 43, the third electronic device 44 and the fourth electronic device 45 are connected with each other via the network router 41 through network connection. The network router 41, the first electronic device 42, the second electronic device 43, the third electronic device 44 and the fourth electronic device 45 are collaboratively defined as an area network system. The first electronic device 42 is connected to the network router 41 through network connection. A first media file M1, a second media file M2 and a third media file M3 are stored in the first electronic device 42. The first media file M1 is contained in a first default folder Fp1. The second media file M2 is contained in a second default folder Fp2. The third media file M3 is contained in a third default folder Fp3. For example, the first media file M1 is a video file, the second media file M2 is an audio file, and the third media file M3 is a photo file.

The first electronic device 42 comprises a storage element 421 and a controlling unit 422. The storage element 421 is included in the first electronic device 42 for storing the first media file M1, the second media file M2 and the third media file M3. The controlling unit 422 is connected to the storage element 421. The functions of the controlling unit 422 will be illustrated in more details later. The second electronic device 43 is connected to the network router 41 through network connection. Moreover, via the network router 41, the second electronic device 43 is connected with the first electronic device 42 through network connection. When the second electronic device 43 is connected with the first electronic device 42 through network connection, the first default folder Fp1, the second default folder Fp2 and the third default folder Fp3 are display on the second electronic device 43. In this embodiment, the first electronic device 42 is a digital media server, the storage element 421 is a hard disc, and the controlling unit 422 is a microprocessor. In this embodiment, the second electronic device 43 is an active control device such as a digital media controller or a digital media player.

The second electronic device 43 comprises a display screen 431 and an operation interface 432. The first default folder Fp1, the second default folder Fp2, the third default folder Fp3, the first media file M1, the second media file M2 and the third media file M3 may be displayed on the display screen 431. Via the operation interface 432, the user may operate the first default folder Fp1, the second default folder Fp2, the third default folder Fp3, the first media file M1, the second media file M2 and the third media file M3 in order to generate corresponding operation commands. In this embodiment, the second electronic device 43 is a digital media controller (i.e. one kind of active control device). The display screen 431 and the operation interface 432 are combined as a touch screen. Moreover, the network router 41 complies with the universal plug and play (UPnP) protocol. Moreover, both of the first electronic device 42 and the second electronic device 43 comply with the Digital Living Network Alliance (DLNA) protocol.

Please refer to FIG. 4 again. A fourth media file M4 and a fifth media file M5 are stored in the third electronic device 44. In addition, the fourth media file M4 is contained in a first shared folder Fs1, and the fifth media file M5 is contained in a second shared folder Fs2. A sixth media file M6 is stored in the fourth electronic device 45. In addition, the sixth media file M6 is contained in a third shared folder Fs3. The first shared folder Fs1 has a first folder property information (not shown), the second shared folder Fs2 has a second folder property information (not shown), and the third shared folder Fs3 has a third folder property information (not shown). In this embodiment, each of the third electronic device 44 and the fourth electronic device 45 is a desktop computer or a notebook computer. Moreover, the fourth media file M4 is a video file, the fifth media file M5 is an audio file, and the sixth media file M6 is a photo file.

Moreover, when the shared folders Fs1˜Fs3 are connected to other electronic devices through network connection, the users may browse or operate the media files M4˜M6 of the shared folders Fs1˜Fs3 through other electronic devices. That is, the shared folders Fs1˜Fs3 are the folders that have the network sharing functions. In an embodiment, the first folder property information at least contains a first folder name information and a first folder path information; the second folder property information at least contains a second folder name information and a second folder path information; and the third folder property information at least contains a third folder name information and a third folder path information. The first folder name information denotes the folder name of the first shared folder Fs1, and the first folder property information denotes the website address of the first shared folder Fs1. Similarly, the second folder name information denotes the folder name of the second shared folder Fs2, and the second folder property information denotes the website address of the second shared folder Fs2. Similarly, the third folder name information denotes the folder name of the third shared folder Fs3, and the third folder property information denotes the website address of the third shared folder Fs3.

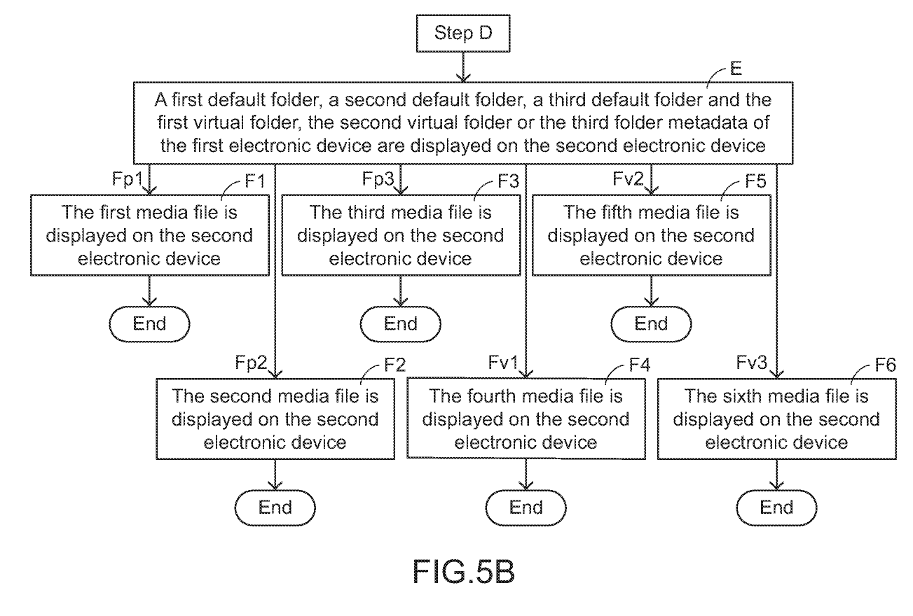

Hereinafter, a media file displaying method according to the present invention will be illustrated with reference to FIGS. 5A and 5B. FIGS. 5A and 5B are flowcharts illustrating a media file displaying method according to an embodiment of the present invention. The media file displaying method comprises the following steps.

Firstly, in a step A, the first electronic device searches the third electronic device and the fourth electronic device in the area network system. In a step B, the third electronic device issues a first shared folder list to the first electronic device, and the fourth electronic device issues a second shared folder list to the first electronic device. In a step C, a first folder property information of a first shared folder is written into a first folder metadata of the first shared folder and a second folder property information of a second shared folder is written into a second folder metadata of the second shared folder according to the first shared folder list, and a third folder property information of a third shared folder is written into a third folder metadata of the third shared folder according to the second shared folder list. In a step D, the first shared folder is correlated with a first virtual folder of the first electronic device according to the first folder metadata, the second shared folder is correlated with a second virtual folder of the first electronic device according to the second folder metadata, or the third shared folder is correlated with a third virtual folder of the first electronic device according to the third folder metadata. In a step E, a first default folder, a second default folder, a third default folder and the first virtual folder, the second virtual folder or the third folder metadata of the first electronic device are displayed on the second electronic device. In a step F, a first media file, a second media file, a third media file, a fourth media file, a fifth media file or a sixth media file is selectively displayed on the second electronic device.

The step F comprises the following sub-steps F1˜F6. In the sub-step F1, the first media file is displayed on the second electronic device. In the sub-step F2, the second media file is displayed on the second electronic device. In the sub-step F3, the third media file is displayed on the second electronic device. In the sub-step F4, the fourth media file is displayed on the second electronic device. In the sub-step F5, the fifth media file is displayed on the second electronic device. In the sub-step F6, the sixth media file is displayed on the second electronic device.

If the first default folder Fp1 is selected in the step E, the sub-step F1 is performed. If the second default folder Fp2 is selected in the step E, the sub-step F2 is performed. If the third default folder Fp3 is selected in the step E, the sub-step F3 is performed. If the first virtual folder Fv1 is selected in the step E, the sub-step F4 is performed. If the second virtual folder Fv2 is selected in the step E, the sub-step F5 is performed. If the third virtual folder Fv3 is selected in the step E, the sub-step F6 is performed.

The folder metadata of the shared folder describes the data property information in order to indicate the storage location, the history data, the resource search, the file record or any other appropriate information. In other words, the metadata is an electronic list for achieving a list editing function. The metadata describes the contents or the features of the shared folder in order to facilitate searching the media folder.

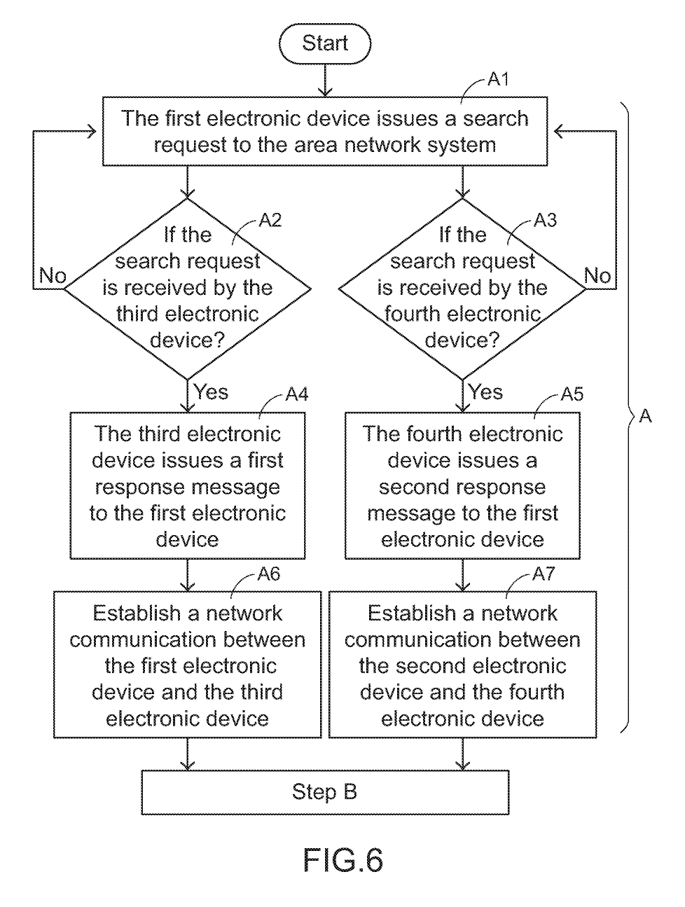

Hereinafter, the detailed procedures of the step A of the media file displaying method will be illustrated with reference to FIG. 6. FIG. 6 is a flowchart illustrating the step A of the media file displaying method according to the embodiment of the present invention. The step A comprises the following sub-steps A1˜A7.

In the sub-step A1, the first electronic device issues a search request to the area network system. The sub-step A2 is performed to judge whether the search request is received by the third electronic device. The sub-step A3 is performed to judge whether the search request is received by the fourth electronic device. In the sub-step A4, the third electronic device issues a first response message to the first electronic device. In the sub-step A5, the fourth electronic device issues a second response message to the first electronic device. In the sub-step A6, a network communication between the first electronic device and the third electronic device is established. In the sub-step A7, a network communication between the second electronic device and the fourth electronic device is established.

If the judging result of the sub-step A2 indicates that the search request is not received by the third electronic device, the sub-step A1 is performed again. Whereas, if the judging result of the sub-step A2 indicates that the search request is received by the third electronic device, the sub-step A4 is performed. If the judging result of the sub-step A3 indicates that the search request is not received by the fourth electronic device, the sub-step A1 is performed again. Whereas, if the judging result of the sub-step A3 indicates that the search request is received by the fourth electronic device, the sub-step A5 is performed.

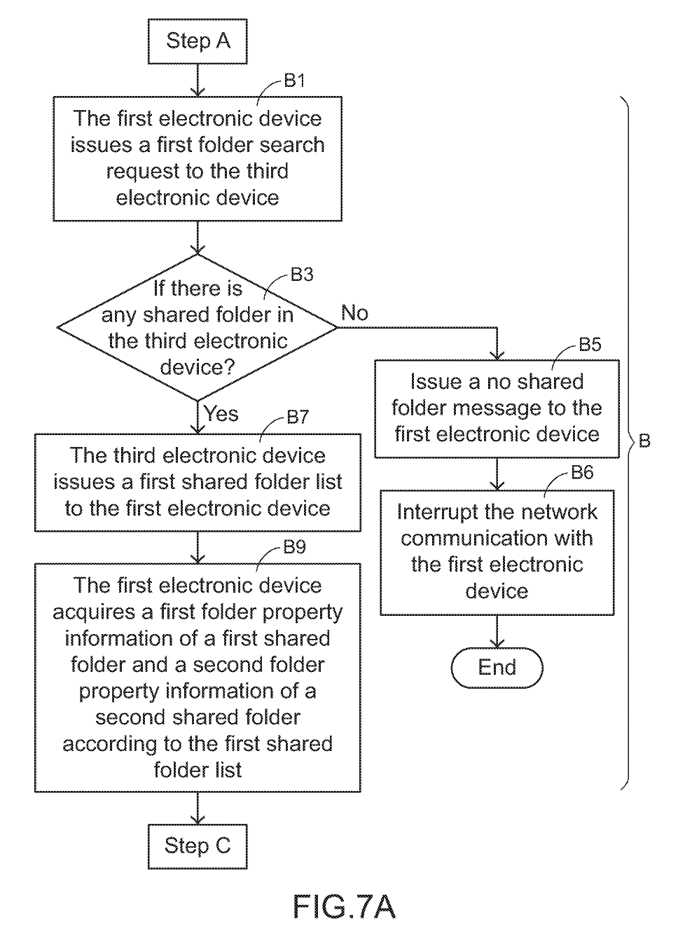

Hereinafter, the detailed procedures of the step B of the media file displaying method will be illustrated with reference to FIGS. 7A and 7B. FIGS. 7A and 7B are flowcharts illustrating the step B of the media file displaying method according to the embodiment of the present invention. The step B comprises the following sub-steps B1˜B10.

In the sub-step B1, the first electronic device issues a first folder search request to the third electronic device. In the sub-step B2, the first electronic device issues a second folder search request to the fourth electronic device. The sub-step B3 is performed to judge whether there is any shared folder in the third electronic device. The sub-step B4 is performed to judge whether there is any shared folder in the fourth electronic device. In the sub-step B5, the third electronic device issues a no shared folder message to the first electronic device. In the sub-step B6, the network communication between the first electronic device and the third electronic device is interrupted. In the sub-step B7, the third electronic device issues a first shared folder list to the first electronic device. In the sub-step B8, the fourth electronic device issues a second shared folder list to the first electronic device. In the sub-step B9, the first electronic device acquires a first folder property information of a first shared folder and a second folder property information of a second shared folder according to the first shared folder list. In the sub-step B10, the first electronic device acquires a third folder property information of a third shared folder according to the second shared folder list.

If the judging result of the sub-step B3 indicates that there is a shared folder in the third electronic device, the sub-step B7 is performed. Whereas, if the judging result of the sub-step B3 indicates that there is no shared folder in the third electronic device, the sub-step B5 is performed. If the judging result of the sub-step B4 indicates that there is a shared folder in the fourth electronic device, the sub-step B8 is performed. Whereas, if the judging result of the sub-step B4 indicates that there is no shared folder in the fourth electronic device, the sub-step B5 is performed.

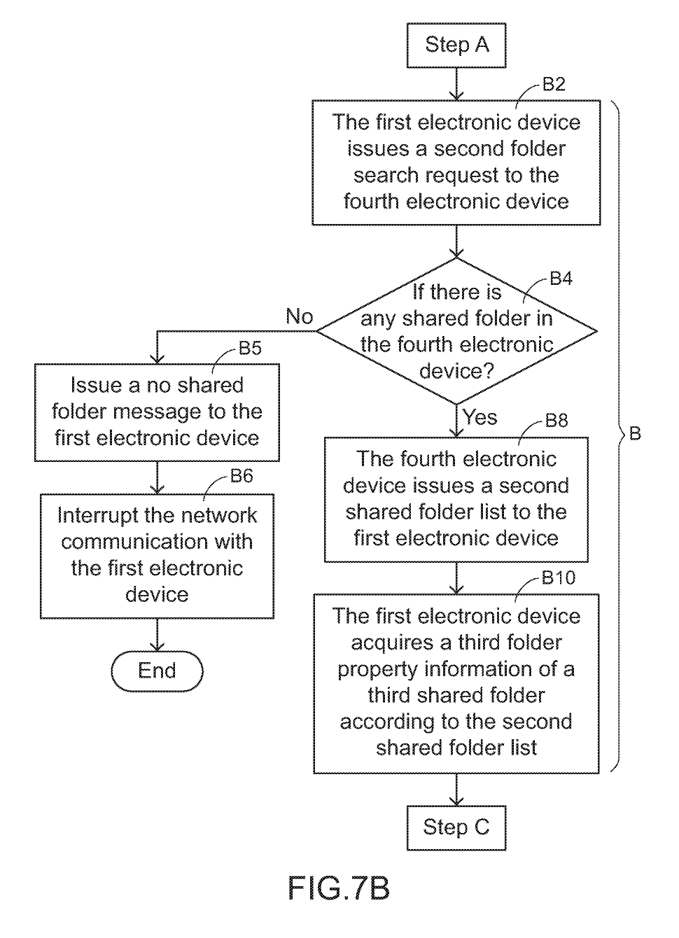

Hereinafter, the detailed procedures of the step C of the media file displaying method will be illustrated with reference to FIG. 8. FIG. 8 is a flowchart illustrating the step C of the media file displaying method according to the embodiment of the present invention. The step C comprises the following sub-steps C1˜C6.

In the sub-step C1, the third electronic device, the first shared folder and the second shared folder are shown in an electronic device inventory of a mount operation interface according to the first shared folder list, and the fourth electronic device and the third shared folder are shown in the electronic device inventory according to the second shared folder list. In the sub-step C2, the first shared folder, the second shared folder or the third shared folder is selected, so that the selected electronic device and the selected shared folder are shown in a mount inventory of the mount operation interface. In the sub-step C3, the folder property information of the selected shared folder is acquired according to the selected shared folder shown in the mount inventory. In the sub-step C4, the media file of the selected shared folder is searched by the first electronic device according to the folder property information. In the sub-step C5, a file property information corresponding to the media file is transmitted from the selected electronic device to the first electronic device. In the sub-step C6, the folder property information is written into the folder metadata of the shared folder, and the file property information is written into a file metadata of the media file.

Before the media file displaying method of the present invention is started, it is necessary to store the first media file M1, the second media file M2 and the third media file M3 into the storage element 421 of the first electronic device 42. The file name of the first media file M1 is 01.MPG. The file name of the second media file M2 is 02.mp3.The file name of the third media file M3 is 03.JPG. Corresponding to video file, the folder name of the first default folder Fp1 is “Video”. Corresponding to the audio file, the folder name of the second default folder Fp2 is “Audio”. Corresponding to the photo file, the folder name of the third default folder Fp3 is “Photo”. The website address of the first media file M1 stored in the storage element 421 is http://DLNA/DMS/Video/01.MPG The website address of the second media file M2 stored in the storage element 421 is http://DLNA/DMS/Audio/02.MP3. The website address of the third media file M3 stored in the storage element 421 is http://DLNA/DMS/Photo/03.JPG.

The term “DMS” in the above website addresses denotes the first electronic device 42. The term “Video”, “Audio” and “Photo” in the above website addresses denotes the first default folder Fp1, the second default folder Fp2 and the third default folder Fp3 that are previously stored in the storage element 421. That is, the first media file M1 with the file name “01.MPG” is stored in the first default folder Fp1 of the first electronic device 42. The rest may be deduced by analogy. The method of storing the first media file M1, the second media file M2 and the third media file M3 into the storage element 421 is well known to those skilled in the art, and is not redundantly described herein. Similarly, the fourth media file M4 is stored in the first shared folder Fs1 of the third electronic device 44, and the folder name of the first shared folder Fs1 is “Video”. Similarly, the fifth media file M5 is stored in the second shared folder Fs2 of the third electronic device 44, and the folder name of the second shared folder Fs2 is “Audio”. Similarly, the sixth media file M6 is stored in the third shared folder Fs3 of the fourth electronic device 45, and the folder name of the third shared folder Fs3 is “Photo”.

Hereinafter, the detailed procedures of the media file displaying method performed by the area network system 4 of the present invention will be illustrated with reference to FIGS. 4, 5 and 6. After the first media file M1, the second media file M2 and the third media file M3 are stored into the storage element 421, the media file displaying method is started. First of all, the first electronic device 42 issues a search request S1 through the network router 41. That is, the sub-step A1 is performed. Then, the third electronic device 44 and the fourth electronic device 45 judge whether the search request S1 is received. That is, the sub-steps A2 and A3 are performed. If the third electronic device 44 judges that the search request S1 is received, the third electronic device 44 issues a first response message R1 to the first electronic device 42. That is, the sub-step A4 is performed. Whereas, if the third electronic device 44 judges that the search request S1 is not received, the sub-step A1 is performed again. If the fourth electronic device 45 judges that the search request S1 is received, the fourth electronic device 45 issues a second response message R2 to the first electronic device 42. That is, the sub-step A5 is performed. Whereas, if the fourth electronic device 45 judges that the search request S1 is not received, the sub-step A1 is performed again. After the first response message R1 is received by the first electronic device 42, the network communication between the first electronic device 42 and the third electronic device 44 is established. That is, the sub-step A6 is performed. After the second response message R2 is received by the first electronic device 42, the network communication between the first electronic device 42 and the fourth electronic device 45 is established. That is, the sub-step A7 is performed.

Please refer to FIGS. 4, 5 and 7. After the network communication between the first electronic device 42 and the third electronic device 44 and the network communication between the first electronic device 42 and the fourth electronic device 45 are established, the first electronic device 42 performs the sub-steps B1 and B2. In the sub-step B1, the first electronic device 42 issues a first folder search request S2 to the third electronic device 44. In the sub-step B2, the first electronic device 42 issues a second folder search request S3 to the fourth electronic device 45. After the first folder search request S2 is received by the third electronic device 44, the sub-step B3 is performed to judge whether there is any shared folder with a network sharing function in the third electronic device 44. Since the first shared folder Fs1 and the second shared folder Fs2 are searched from the third electronic device 44, the third electronic device 44 issues a first shared folder list L1 to the first electronic device 42. That is, the sub-step B7 is performed. The first shared folder list L1 contains the first folder property information corresponding to the first shared folder Fs1 and the second folder property information corresponding to the second shared folder Fs2. Whereas, if there is no shared folder in the third electronic device 44, the third electronic device 44 issues a no shared folder message (not shown) to the first electronic device 42 (i.e. the sub-step B5), and then the network communication between the first electronic device 42 and the third electronic device 44 is interrupted (i.e. the sub-step B6).

Similarly, after the second folder search request S3 is received by the fourth electronic device 45, the sub-step B4 is performed to judge whether there is any shared folder with a network sharing function in the fourth electronic device 45. Since the third shared folder Fs3 is searched from the fourth electronic device 45, the fourth electronic device 45 issues a second shared folder list L2 to the first electronic device 42. That is, the sub-step B8 is performed. The second shared folder list L2 contains the third folder property information corresponding to the third shared folder Fs3. Whereas, if there is np shared folder in the fourth electronic device 45, the fourth electronic device 45 issues a no shared folder message (not shown) to the first electronic device 42 (i.e. the sub-step B5), and then the network communication between the first electronic device 42 and the fourth electronic device 45 is interrupted (i.e. the sub-step B6).

After the first shared folder list L1 is received by the first electronic device 42, the first electronic device 42 acquires the first folder property information of the first shared folder Fs1 and the second folder property information of the second shared folder Fs2 from the first shared folder list L1. That is, the sub-step B9 is performed. Similarly, after the second shared folder list L2 is received by the first electronic device 42, the first electronic device 42 acquires the third folder property information of the third shared folder Fs3 from the second shared folder list L2. That is, the sub-step B10 is performed.

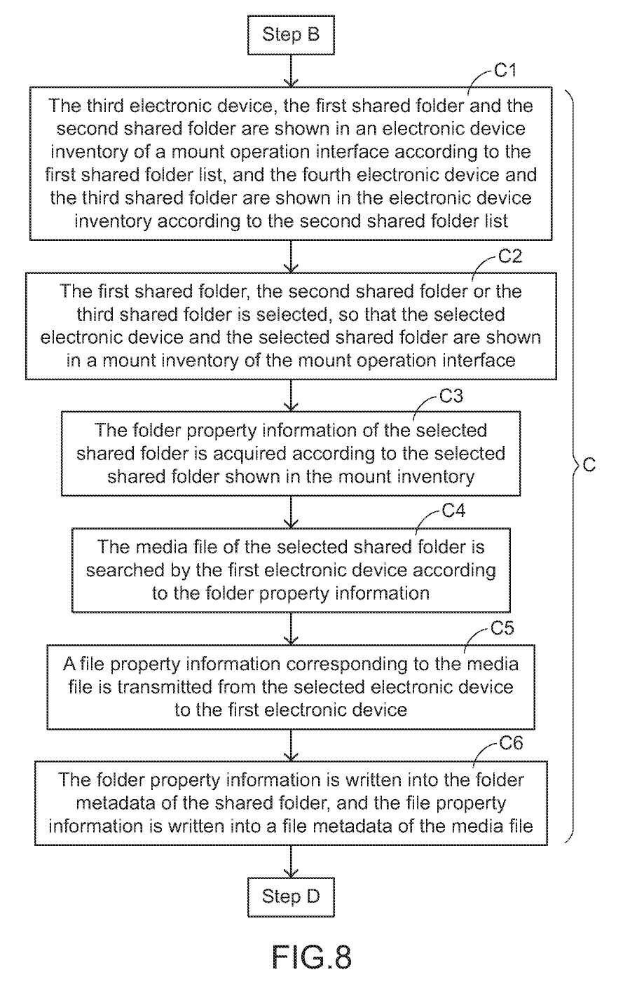

The detailed procedures of the step C of the media file displaying method will be illustrated in more details as follows. The step C comprises a folder selecting procedure (including the sub-steps C1 and C2) and a metadata writing procedure (including the sub-steps C3˜C6). Firstly, the folder selecting procedure will be illustrated with reference to FIGS. 4, 5, 8 and 9. FIG. 9 schematically illustrates a mount operation interface of the area network system according to the embodiment of the present invention. After the first folder property information, the second folder property information and the third folder property information are acquired by the first electronic device 42, the user may operate a mount operation interface 46 of a third-party device to select one or more shared folders to be mounted onto the first electronic device 42. The mount operation interface 46 is shown in FIG. 9. As shown in FIG. 9, the mount operation interface 46 comprises a website address bar 461, an electronic device inventory 462, a mount inventory 463, an add item 464, and a delete item 465. The website address bar 461 is located at a top side of the mount operation interface 46. Via the website address bar 461, the user may input the website address of the first electronic device 42, so that the third-party device is connected to the first electronic device 42 through network connection. Consequently, the subsequent mounting task may be further performed. The electronic device inventory 462 is located at a left side of the mount operation interface 46. The electronic device inventory 462 contains the third electronic device 44, the first shares folder Fs1 and the second shared folder Fs2 of the first shared folder list L1 and the fourth electronic device 45 and the third shares folder Fs3 of the second shared folder list L2. The mount inventory 463 is located at a right side of the mount operation interface 46 for displaying the selected shared folders, i.e. the shared folders to be mounted onto the first electronic device 42. By clicking the add item 464, the selected shared folder is added to the mount inventory 463. By clicking the delete item 465, the selected shared folder is deleted from the mount inventory 463.

After the third-party device is connected to the first electronic device 42 through network connection via the website address bar 461, the folder selecting procedure is started. Since the first shared folder list L1 and the second shared folder list L2 have been acquired by the first electronic device 42, the third electronic device 44, the first shares folder Fs1 and the second shared folder Fs2 of the first shared folder list L1 and the fourth electronic device 45 and the third shares folder Fs3 of the second shared folder list L2 are shown in the electronic device inventory 462. That is, the sub-step C1 is performed. Then, the user may select the first shares folder Fs1 and the second shared folder Fs2. By clicking the add item 464, the first shares folder Fs1 and the second shared folder Fs2 are added to the mount inventory 463. That is, the sub-step C2 is performed. Of course, by clicking the delete item 465, the shared folder may be detected from the mount inventory 463.

After the first shares folder Fs1 and the second shared folder Fs2 are added to the mount inventory 463, the first folder property information of the first shared folder Fs1 and the second folder property information of the second shared folder Fs2 are acquired by the controlling unit 422. That is, the sub-step C3 is performed. According to the first folder name information and the first folder path information of the first folder property information and the second folder name information and a second folder path information of the second folder property information, the controlling unit 422 is connected to the third electronic device 44 through network connection in order to search the fourth media file M4 of the first shares folder Fs1 and the fifth media file M5 of the second shared folder Fs2. That is, the sub-step C4 is performed. Then, a fourth file property information of the fourth media file M4 and a fifth file property information of the fifth media file M5 are transmitted from the third electronic device 44 to the first electronic device 42. That is, the sub-step C5 is performed.

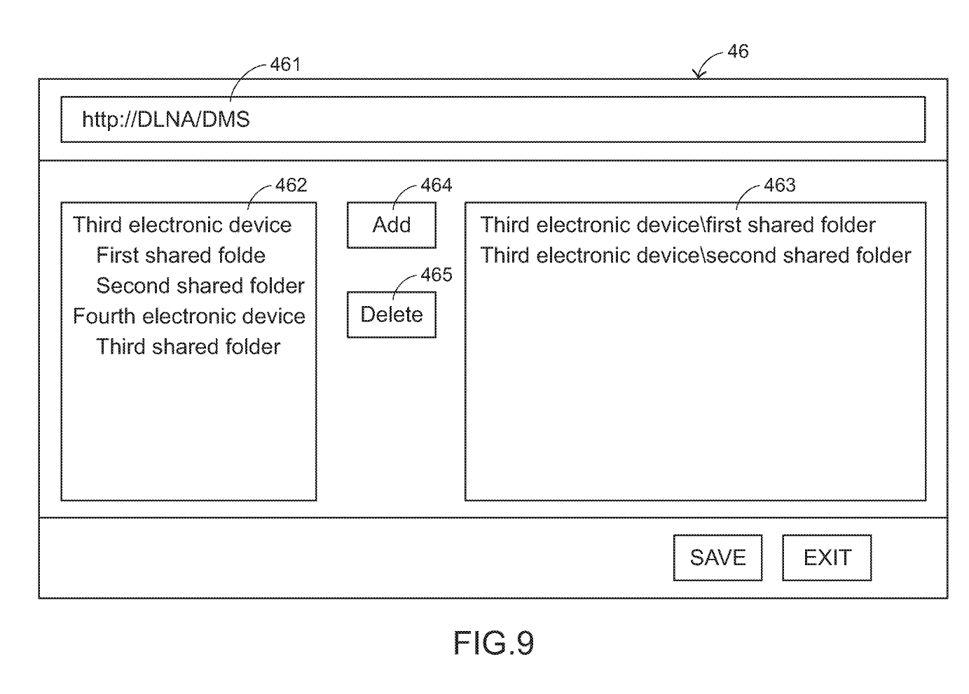

Afterwards, the first electronic device 42 writes the first folder property information of the first shared folder Fs1 into a first folder metadata MD1 of the first shared folder Fs1, and writes the second folder property information of the second shared folder Fs2 into a second folder metadata MD2 of the second shared folder Fs2. In addition, the first electronic device 42 writes the fourth file property information into a first file metadata MD4 of the fourth media file M4 and writes the fifth file property information into a second file metadata MD5 of the fifth media file M5. That is, the sub-step C6 is performed. The contents of the first folder metadata MD1, the second folder metadata MD2, the first file metadata MD4 and the second file metadata MD5 are shown in FIG. 10.

Please refer to FIGS. 4 and 5 again. After the first folder metadata MD1, the second folder metadata MD2, the first file metadata MD4 and the second file metadata MD5 are acquired, a first virtual folder Fv1 corresponding to the first shared folder Fs1 and a second virtual folder Fv2 corresponding to the second shared folder Fs2 are created by the controlling unit 422. That is, the step D is performed. Meanwhile, the first shared folder Fs1 and the second shared folder Fs2 are mounted onto the first electronic device 42. Then, the user may operate the second electronic device 43 to communicate the second electronic device 43 with the first electronic device 42 through network connection. Consequently, the first electronic device 42 issues a third folder list L3 to the second electronic device 43. Consequently, the first default folder Fp1, the second default folder Fp2 and the third default folder Fp3 of the first electronic device 42 and the first virtual folder Fv1 and the second virtual folder Fv2 mounted onto the first electronic device 42 are shown on the second electronic device 43. That is, the step E is performed.

In the sub-step F1, if the first default folder Fp1 is selected by the user via the operation interface 432 of the second electronic device 43, the second electronic device 43 correspondingly issues a first select signal O1 to the first electronic device 42. In response to the first select signal O1, the first media file M1 is acquired and formed as a first list packet P1 by the controlling unit 422, and the first list packet P1 is transmitted to the second electronic device 43. In response to the first list packet P1, the first media file M1 is displayed on the display screen 431 of the second electronic device 41. The website address of the first media file M1 displayed on the second electronic device 43 is http://DLNA/DMS/Video/01.MPG The term “Video” indicates the folder name of the first default folder Fp1. The operations of the sub-steps F2 and F3 are similar to the operation of the sub-step F1, and are not redundantly described herein.

In the sub-step F4, if the first virtual folder Fv1 is selected by the user via the operation interface 432 of the second electronic device 43, the second electronic device 43 correspondingly issues a fourth select signal O4 to the first electronic device 42. In response to the fourth select signal O4 and the first folder path information of the first folder metadata MD1, a first uniform resource locator (URL) U1 corresponding to the first shared folder Fs1 is transmitted from the controlling unit 422 to the second electronic device 43. According to the first uniform resource locator U1, the second electronic device 43 realizes that the real location of the first shared folder Fs1 is in the third electronic device 44 rather than the first electronic device 42. Then, the second electronic device 43 issues a file-requesting command S4 to the first electronic device 42, and the first electronic device 42 issues a first transmission command O7 to the third electronic device 44. Consequently, the fourth media file M4 is acquired and formed as a fourth list packet P4 by the third electronic device 44, and the fourth list packet P4 is transmitted from the third electronic device 44 to the first electronic device 42. Then, the fourth list packet P4 is transmitted from the first electronic device 42 to the second electronic device 43. Consequently, the fourth media file M4 corresponding to the first virtual folder Fv1 is displayed on the display screen 431 of the second electronic device 41. The website address of the fourth media file M4 displayed on the second electronic device 43 is http://DLANA/ED3/Video/04.MPG. The term “Video” indicates the folder name of the first virtual folder Fv1. The operations of the sub-steps F5 and F6 are similar to the operation of the sub-step F4, and are not redundantly described herein.

Meanwhile, the media file displaying method of the present invention is completed. In addition, the user may perform a subsequent operation on the selected media file via the operation interface 432.

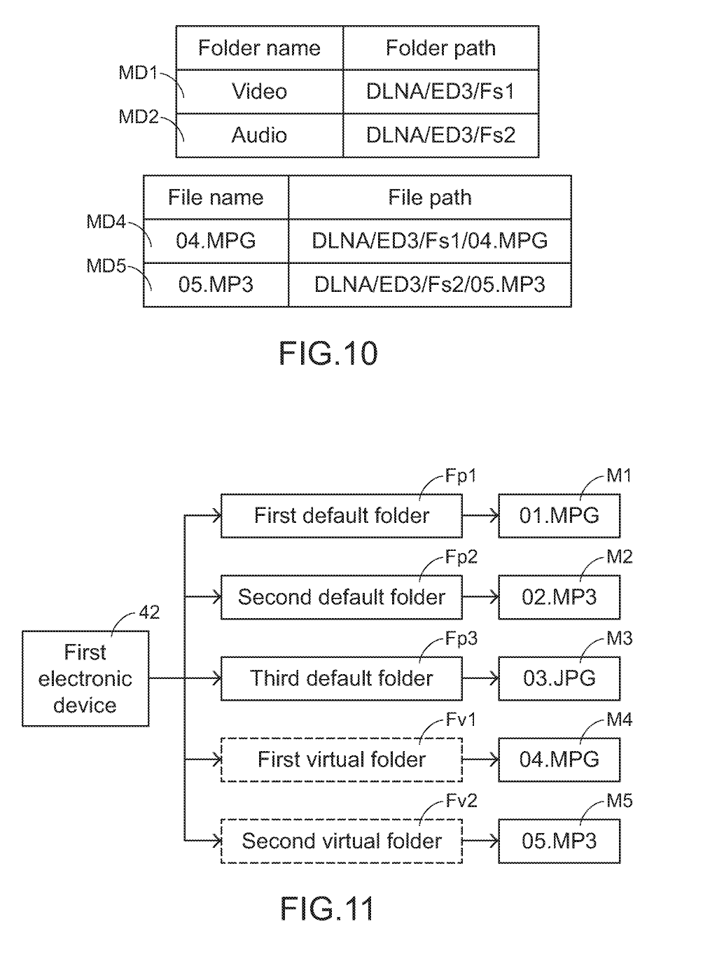

FIG. 11 schematically illustrates the folder architecture of the first electronic device of the area network system according to the embodiment of the present invention. By implementing the photo file displaying method of the present invention, the area network system 4 is capable of mounting the first shares folder Fs1 and the second shared folder Fs2 of the third electronic device 44 onto the first electronic device 42. The folder architecture of the first electronic device 42 is clearly shown in FIG. 11. The first electronic device 42 comprises the first default folder Fp1, the second default folder Fp2 and the third default folder Fp3, which are really present in the first storage element 421. In addition, the first electronic device 42 further comprises the first virtual folder Fv1 (indicated by dotted line) and the second virtual folder Fv2 (indicated by dotted line), which are not really present in the first storage element 421. That is, the area network system 4 is capable of mounting the shared folders of different electronic devices onto the first electronic device 42. By simply connecting to the first electronic device 42 through network connection, the user can browse all shared folders that are able to be shared to the first electronic device 42. Since it is not necessary to repeatedly connect to different electronic devices through network connection, the user-friendliness of using the area network system is enhanced.

Moreover, the folder architecture of the first electronic device may have different arrangement according to the settings of the controlling unit 422. For example, the fourth file property information of the fourth media file M4 may further contain a file type property information. According to the file type property information, the controlling unit 422 judges that the fourth media file M4 is a video file. Consequently, the fourth media file M4 is assigned to the first default folder Fp1. When the user operates the second electronic device 43 to browse the contents of the first default folder Fp1, the video files including the first media file M1 and the fourth media file M4 may be simultaneously viewed by the user. Under this circumstance, the user can easily search the desired media file.

From the above descriptions, the present invention provides an area network system and a media file displaying method. By setting the folder metadata of the shared folders of different electronic devices, the shared folders of different electronic devices may be correlated with a digital media server. When an active control device is connected to the digital media server through network connection, plural media files may be browsed by the user. The virtual folders corresponding to the shared folders can be displayed on the active control device. Moreover, the user may operate the active control device to browse plural media files of different electronic device. Since it is not necessary to manually connect to these electronic devices through network connection, the browsing convenience is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A media file displaying method, comprising steps of:
(A) allowing a first electronic device to search a second electronic device in an area network system;
(B) issuing a shared folder list corresponding to the second electronic device from the second electronic device to the first electronic device, wherein the shared folder list contains a folder property information of a shared folder of the second electronic device, wherein the first electronic device comprises a default folder;
(C) writing the folder property information into a folder metadata of the shared folder according to the shared folder list;
(D) correlating the shared folder with a virtual folder of the first electronic device according to the folder metadata of the shared folder;
(E) allowing a third electronic device in the area network system to communicate with the first electronic device through network connection, so that the default folder and the virtual folder corresponding to the shared folder are displayed on the third electronic device; and
(F) selecting the default folder or the virtual folder, wherein if the default folder is selected, a first media file contained in the default folder is displayed on the third electronic device, wherein if the virtual folder is selected, a second media file corresponding to the virtual folder is displayed on the third electronic device.

2. The media file displaying method according to claim 1, wherein the step (A) comprises sub-steps of:
(A1) issuing a search request from the first electronic device to the second electronic device;
(A2) issuing a response message corresponding to the search request from the second electronic device to the first electronic device; and
(A3) establishing a network communication between the first electronic device and the second electronic device.

3. The media file displaying method according to claim 2, wherein the step (B) comprises sub-steps of:
(B1) issuing a folder search request from the first electronic device to the second electronic device;
(B2) issuing the shared folder list from the second electronic device to the first electronic device in response to the folder search request; and
(B3) acquiring the folder property information of the shared folder by the first electronic device according to the shared folder list.

4. The media file displaying method according to claim 3, wherein the step (C) comprises sub-steps of:
(C1) allowing the second electronic device and the shared folder to be shown in an electronic device inventory of a mount operation interface according to the shared folder list;
(C2) selecting the shared folder, so that the second electronic device and the selected shared folder are shown in a mount inventory of the mount operation interface;
(C3) acquiring the folder property information of the selected shared folder according to the second electronic device and the selected shared folder shown in the mount inventory;
(C4) searching the second media file of the selected shared folder by the first electronic device according to the folder property information;
(C5) transmitting a file property information corresponding to the second media file from the second electronic device to the first electronic device; and
(C6) writing the folder property information into the folder metadata of the shared folder, and writing the file property information into a file metadata of the second media file.

5. The media file displaying method according to claim 1, wherein each of the first media file and the second media file is a video file, an audio file or a photo file, wherein the first electronic device is a digital media server according to a DLNA protocol, the second electronic device is a notebook computer or a desktop computer, and the third electronic device is a digital media controller or a digital media player according to the DLNA protocol.

6. An area network system, comprising:
a network router providing a network connection function;
an electronic device connected to the network router through network connection, wherein the electronic device comprises a second media file, and the second media file is contained in a shared folder, wherein a shared folder list corresponding to the shared folder is outputted from the electronic device;
a digital media server connected to the network router through network connection and connected to the electronic device via the network router through network connection, wherein the digital media server stores a first media file and receives the shared folder list, wherein the digital media server comprises a storage element and a controlling unit, wherein the storage element is disposed within the digital media server, and the first media file is stored in the storage element, wherein the first media file is contained in a default folder, wherein the controlling unit is connected with the storage element, and the controlling unit writes a folder property information of the shared folder into a folder metadata of the shared folder according to the shared folder list, so that the shared folder is correlated with a virtual folder of the digital media server; and
an active control device connected to the network router through network connection and connected to the digital media server via the network router through network connection, wherein the default folder and the virtual folder are displayed on the active control device, wherein if the default folder is selected, the first media file contained in the default folder is displayed on the active control device, wherein if the virtual folder is selected, the second media file corresponding to the virtual folder is displayed on the active control device.

7. The area network system according to claim 6, wherein when the digital media server issues a search request to the electronic device through the network router, a response message corresponding to the search request is transmitted from the electronic device to the digital media server, so that the digital media server issues a folder search request to the electronic device, wherein when the folder search request is received by the electronic device, the electronic device issues the shared folder list to the digital media server, so that the controlling unit acquires the folder property information of the shared folder according to the shared folder list.

8. The area network system according to claim 7, wherein the shared folder is correlated with the virtual folder of the digital media server by the digital media server through a mount operation interface, wherein the mount operation interface comprises:
an electronic device inventory showing the electronic device and the shared folder of the shared folder list;
a mount inventory showing the shared folder corresponding to the virtual folder;
an add item, wherein when the shared folder is selected and the add item is clicked, the selected shared folder is added to the mount inventory; and
a delete item, wherein when the delete item is clicked, the selected shared folder is deleted from the mount inventory,
wherein after the selected shared folder is added to the mount inventory, the digital media server searches the second media file of the shared folder, so that the a file property information corresponding to the media file is transmitted from the electronic device to the digital media server, wherein the controlling unit writes the folder property information into the folder metadata and writes the file property information into a file metadata of the second media file, so that the shared folder is correlated with the virtual folder.

9. The area network system according to claim 6, wherein if the default folder is selected, the first media file in the default folder is acquired and formed as a first list packet by the controlling unit, and the first list packet is transmitted from the controlling unit to the active control device, so that the first media file corresponding to the default folder is displayed on the active control device, wherein if the virtual folder is selected, a uniform resource locator corresponding to the shared folder is transmitted from the controlling unit to the active control device according to the folder property information of the folder metadata, and the active control device issues a file-requesting command to the digital media server, so that the controlling unit issues a transmission command to the electronic device, wherein in response to the transmission command, the second media file with the folder property information is acquired and formed as a second list packet by the electronic device, and the second list packet is transmitted from the electronic device to the digital media server, wherein the second list packet is further transmitted from the digital media server to the active control device, so that the second media file corresponding to the virtual folder is displayed on the active control device.

10. The area network system according to claim 6, wherein the digital media server and the active control device comply with a DLNA protocol, and the network router complies with a UPnP protocol, wherein each of the first media file and the second media file is a video file, an audio file or a photo file.
